(19) United States
(12) Patent Application Publication
(10) Pub. No.: US 2026/0058581 A1
(43) Pub. Date: Feb. 26, 2026

(54) ALL-PERMANENT MAGNET COMBINED SELF-STABILIZING MAGLEV BEARING

(71) Applicant: SUZHOU KEQIN MICRO VISION MEDICAL DEVICE CO., LTD., Jiangsu (CN)

(72) Inventor: Baohua Jiang, Jiangsu (CN)

(73) Assignee: SUZHOU KEQIN MICRO VISION MEDICAL DEVICE CO., LTD., Jiangsu (CN)

(21) Appl. No.: 18/684,693

(22) PCT Filed: Aug. 22, 2023
(86) PCT No.: PCT/CN2023/114161

§ 371 Date: May 12, 2025

(30) Foreign Application Priority Data
Apr. 24, 2023 (CN) 202310448814.0

(51) Int. Cl. H02N 15/00

(52) U.S. Cl. CPC H02N 15/00

(57) ABSTRACT

An all-permanent magnet combined self-stabilizing maglev bearing includes a first axial maglev bearing and a second radial maglev bearing arranged on a same rotating shaft, wherein the first axial maglev bearing achieves radial magnetization and axial levitation stabilization, and the second radial maglev bearing achieves axial magnetization and radial levitation stabilization; and the first axial maglev bearing and the second radial maglev bearing each include a stator, a rotor and a rotor bushing, the stator and the rotor being composed of magnetic rings, the rotor is fixed on the rotating shaft by the rotor bushing, and a short circuit ring is arranged between the magnetic rings. The all-permanent magnet self-stabilizing maglev bearing achieves the axial magnetization and radial stabilization of bearings and the radial magnetization and axial stabilization of bearings.

### TECHNICAL FIELD

The present invention relates to the technical field of all-permanent magnet maglev bearings, and particularly relates to an all-permanent magnet combined self-stabilizing maglev bearing.

### RELATED ART

Maglev researches originate from the emergence of permanent magnet materials. It has been found that due to the repulsions or attractions of permanent magnets, the directional autonomous stabilization (also known as fluctuation stabilization) of a bearing at certain degrees of freedom can be achieved, i.e., self-repulsion or attraction radial levitation can be achieved, and thrust axial levitation (YONNER) can also be achieved, but its unstable force is greater than a self-levitation force, therefore, at other degrees of freedom, an external force must be introduced to constrain and overcome the unstable levitation force. In other words, this magnet combination cannot combine, in design, radial and axial levitation bearings into a stable maglev bearing. According to the Earnshaw's Theorem and the Tanks Certification, it is impossible for a magnetic bearing composed only of permanent magnets to achieve stable levitation, and it is unstable at least at one degree of freedom. This deduction has affected many researchers over a long period of time, and has become a routine constraint in the industry. In China, the academic school represented by CIOMP (Changchun Institute of Optics, Fine Mechanics and Physics, Chinese Academy of Sciences) supports this academic view in which a deduction with a specific permanent magnet model is performed using the Laplace's equation and the Law of conservation of energy to obtain a universal law. Furthermore, some scholars call it a perpetual motion machine of the first kind. Of course, in the industry, there have also been individual weak different voices that it is possible to implement all-permanent magnet maglev bearings, for example in Analysis and Design Foundation on Structure Units of All-permanent Magnetic Bearing (https://wenku.baidu.com/view/63b82f2ebb4ae45c3b3567ec102de2bd9605dea0.html). However, after reading the article, its permanent magnet radial/axial levitation structures have not yet deviated from the conventional structure in the industry which has proved impossible to achieve, so it is also a deduction impossible to achieve. But experimental studies have shown that there is at least one permanent magnet combined levitation reconstruction whose self-restoring force stiffness is greater than an unstable force stiffness in an initial section, so the Earnshaw's Theorem and the Tanks Certification are not applicable to the permanent magnet combined reconstruction.

In order to solve the bearing friction energy loss of flywheels (a high-speed energy storage device), rotating machineries for precision engineering, and long-service-life, high-reliability and efficient rotating machineries (such as artificial hearts) that exist in modern engineering, the maglev bearing technology has been greatly developed. In various types of frictionless levitation bearing technologies, people focus on developing electromagnetically controlled electromagnetic attraction maglev bearings (AMB). In terms of technical solutions, the maglev magnetic technical solution of AMB, due to the closure of magnetic circuits, is widely used in the industry because of its advantages of larger bearing capacity and control features in comparison to the permanent magnet passive repulsion maglev solution in which magnetic circuits are opened. The greatest advantage of AMB is that compared with repulsive permanent magnet levitation, AMB can achieve strong motion stability under a large bearing load, but it is an unstable system, is energy-intensive and controlled complicatedly, and requires an expensive electronic and electrical control system, which affects the scope and breadth of its application.

Therefore, energy consumption and cost reduction and reliability improvement are the mainstream direction of the maglev bearing industry. In order to reduce the loss and the cost, AMB bearings generally adopt hybrid bearing solutions, such as permanent magnet hybrid With the breakthrough in the performance of permanent magnet materials, on the one hand, people use permanent magnets to construct permanent magnet-electromagnet composite bearings, and on the other hand, people do not give up efforts to break through the inherent defects of the permanent magnet bearing technology, and many permanent magnet levitation technical solutions have appeared. However, it can be seen that, due to the influence of habitual thinking, many technical paths or ideas to solve the problem are essentially not out of the design category that all-permanent magnet stabilizing maglev bearings cannot be designed and combined based on original permanent magnet repulsion or attraction solutions; in other words, the unstable force is greater than the self-restoring force, i.e., a repulsion solution; the magnetic field increases, the autonomous restoring force in the target direction increases, and the lateral unstable force increases synchronously, i.e., an attraction solution; and the magnetic field increases, the autonomous restoring force in the target direction increases, and the lateral unstable force increases simultaneously. Therefore, permanent magnet radial bearings and permanent magnet axial bearings cannot be designed to form stable all-permanent magnet maglev bearings, which has become an axiom in the industry. In addition, in the repulsion solution, the magnetic circuit is opened, so the loss of the magnetic circuit is large, the performance of permanent magnets is compromised, and thus the bearing capacity of the magnetic bearing is compromised. In the attraction solution, the lateral unstable force is greater than the self-restoring force. Some maglev bearings use repulsion and auxiliary attraction solutions, the essence of which is to set a maglev bias force, but the performance of permanent magnets is also compromised, so such maglev bearings are not all-permanent magnet negative-feedback self-stabilizing maglev bearings.

In addition, Harrigan's maglev gyro, beyond the expectations of the mainstream scientific community, is a new maglev idea, but it is only a rotating dynamic maglev. With the progress of diamagnets and superconductivity technologies, people have also paid attention to diamagnets and superconductors, and use of diamagnets and superconductors is possible to achieve completely uncontrolled levitation, but its equipment is expensive, and the application is limited.

British mathematician Earnshaw's “Earnshaw's Theorem” on the interaction between axisymmetric permanent magnets became a stable inhibition in the field of permanent magnet maglev bearings. All-permanent magnet maglev bearings exit, and mainstream maglev bearing researches turn to active or hybrid maglev. Earnshaw's Theorem is a physical law that cannot be changed, but the mathematical model derived from the Earnshaw's Theorem is the gravitational or repulsive interaction between two symmetrical static unipolar magnets, and in this unipolar magnet structure, the unbalance stiffness is greater than the restoring stiffness. Referring to the document (Shenyang Institute of Automation, Chinese Academy of Sciences) Derivation of Laplace Equation, when it is used as an all-permanent magnet maglev bearing, an external force must be introduced to overcome the unbalanced force in order to ensure the levitation stabilization in the levitation direction. Radial maglev bearings and axial maglev bearings that are of this structure cannot form stable all-permanent maglev bearings.

### SUMMARY OF INVENTION

To solve the problems in the above-mentioned background art, an all-permanent magnet combined self-stabilizing maglev bearing is provided, which includes a first axial maglev bearing and a second radial maglev bearing arranged on a same rotating shaft, where the first axial maglev bearing achieves radial magnetization and axial levitation stabilization, and the second radial maglev bearing achieves axial magnetization and radial levitation stabilization; and
the first axial maglev bearing and the second radial maglev bearing each comprise a stator, a rotor and a rotor bushing, the stator and the rotor being composed of magnetic rings, the rotor is fixed on the rotating shaft by the rotor bushing, and a short circuit ring is arranged between the magnetic rings.

Further, at least one first axial maglev bearing and one second radial maglev bearing are arranged on the rotating shaft.

Further, the numbers of the first axial maglev bearing and the second radial maglev bearing arranged on the rotating shaft are selected according to actual demands.

Further, the first axial maglev bearing comprises a first bearing rotor and a first bearing stator; the first bearing rotor is composed of a plurality of small magnetic rings abutting to each other, a short circuit ring is arranged inside the magnetic rings, and the first bearing rotor is connected to the rotating shaft through a rotor bushing; the first bearing stator is composed of a plurality of large magnetic rings abutting to each other, and a short circuit ring is arranged outside the magnetic rings; and the first bearing rotor is placed in the first bearing stator with a radial clearance.

Further, in the first bearing rotor and the first bearing stator, the magnetic rings abutting to each other are opposite in polarity, and the large and small magnetic rings that are symmetrical in position on the first bearing rotor and the first bearing stator are opposite in polarity.

Further, the second radial maglev bearing includes a second maglev rotor and second maglev stators; the second maglev rotor is formed by nesting an inner magnetic ring in an outer magnetic ring; two sets of the inner and outer magnetic rings are arranged mirror-symmetrically, and a short circuit ring is arranged between the two sets; the second maglev rotor is connected to the rotating shaft through a rotor bushing; the second maglev stator is formed by nesting an inner magnetic ring in an outer magnetic ring, and two sets of the inner and outer magnetic rings are respectively arranged on the two sides of the radial rotor and arranged mirror-symmetrically; and a short circuit ring is arranged on the side of the second maglev stator away from the second maglev rotor with an axial clearance.

Further, in the second maglev rotor and the second maglev stators, the nested inner and outer magnetic rings are opposite in polarity, and the inner and outer magnetic rings that are symmetrical in position on the radial rotor and the radial stators are opposite in polarity.

Further, a conical roller bearing is added on the rotating shaft for protection.

The present invention achieves the following beneficial effects:
(1) the permanent magnet maglev bearing is practicalized and industrialized, widely enters the fields of green energy saving, machine manufacturing, aerospace, silent motion carriers, etc., and has wide applicable scenes;
(2) the energy consumption is reduced, the cost is lowered, and the reliability is improved; and
(3) the static and dynamic autonomous levitation stabilization of completely uncontrolled all-permanent magnet maglev bearings is achieved, which fills the technical gaps in the industry.

### BRIEF DESCRIPTION OF DRAWINGS

FIG. 1 is a mathematical model of an all-permanent magnet maglev bearing according to embodiments of the present invention;

FIG. 2 is a transfer function of the permanent magnet maglev bearing according to embodiments of the present invention;

FIG. 3 is a structural schematic diagram of a first axial maglev bearing according to embodiments of the present invention;

FIG. 4 is a structural schematic diagram of a second radial maglev bearing according to embodiments of the present invention;

FIG. 5 is another example diagram of the first axial maglev bearing according to embodiments of the present invention; and

FIG. 6 is an assembly diagram of the all-permanent magnet maglev bearing according to embodiments of the present invention.

In the figures, 11—small magnetic ring, 12—small magnetic ring, 21—large magnetic ring, 22—large magnetic ring, 31—inner magnetic ring, 32—outer magnetic ring, 41—inner magnetic ring, 42—outer magnetic ring, 51—short circuit ring, 52—short circuit ring, 53—short circuit ring, 54—short circuit ring, 61—rotor bushing, 62—rotor bushing, 7—rotating shaft, 7—rotating shaft.

### DESCRIPTION OF EMBODIMENTS

The technical solution of the present invention will be further described below with reference to the drawings of the Description.

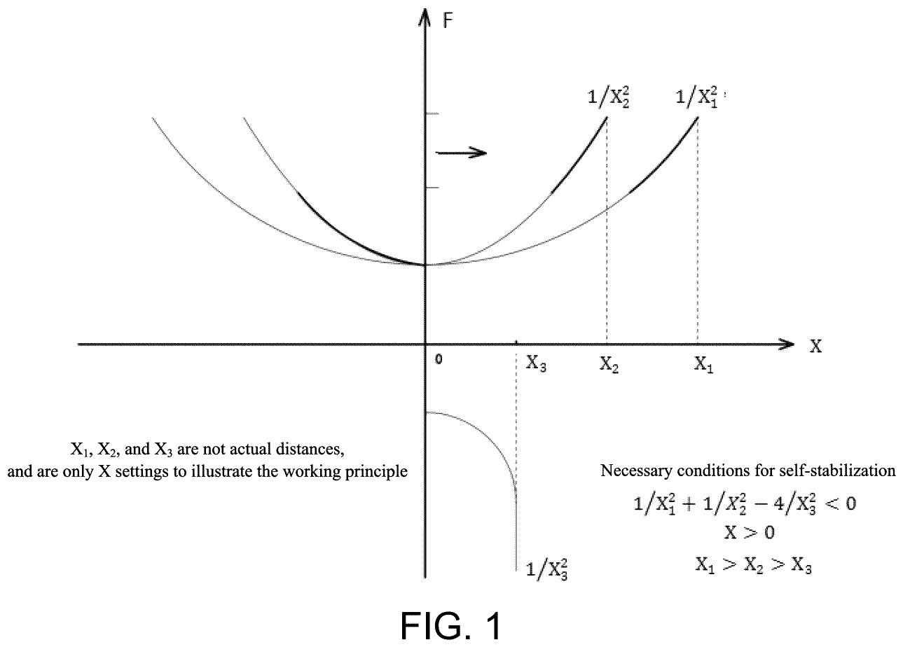

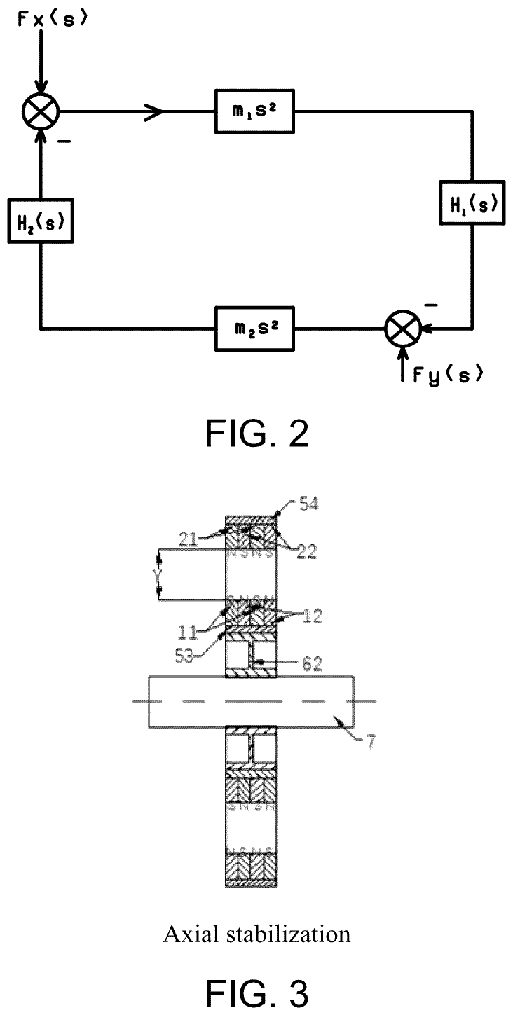

Referring to FIG. 1 and FIG. 2, when an axial external force causes a rotor to produce a displacement in the axial direction, a radially magnetized and axially stabilized bearing produces a negative-feedback restoring force. Near an initial equilibrium position, the negative-feedback restoring force is greater than a sum of a positive-feedback attraction difference and a load, so that an axial bearing tends to be stabilized. Similarly, when a radial external force causes a rotor to produce a displacement in the radial direction, an axially magnetized and stabilized bearing produces a negative-feedback restoring force. Near the initial equilibrium position, the negative-feedback restoring force is greater than a sum of a positive-feedback attraction difference and an external interference force, so that a radial bearing tends to be stabilized. This combined design of the radial bearing and the axial bearing achieves the static and dynamic autonomous levitation stabilization of an all-permanent magnet maglev bearing.

Referring to FIG. 3, a structural composition of a first axial maglev bearing includes a first maglev rotor and a first maglev stator; the rotor is composed of two small magnetic rings 11 and two small magnetic rings 12 by means of abutment, a short circuit ring 53 is arranged on the inner sides of the small magnetic rings 11 and 12 by means of abutment, and the rotor is connected to a rotating shaft 7 through a rotor bushing 62; the stator is composed of two large magnetic rings 21 and two large magnetic rings 22 by means of abutment, and a short circuit ring 54 is arranged outside the large magnetic rings 21 and 22; and the rotor is placed in the stator with a radial clearance (the sizes of the radial clearance and an axial clearance depend on the size of a load required by a project). Referring to FIG. 5, the number of the magnetic rings can be selected according to actual needs, and for example, half of the magnetic rings is omitted in FIG. 5 compared to FIG. 3.

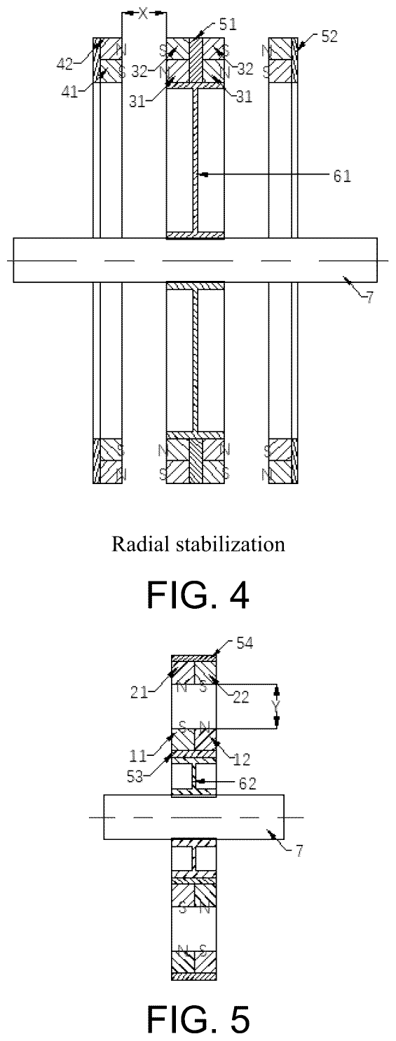

Referring to FIG. 4, a structural composition of a second radial maglev bearing includes a second maglev rotor and two second maglev stators; the radial rotor is formed by nesting an inner magnetic ring 31 in an outer magnetic ring 32, the two sets of inner and outer magnetic rings are arranged mirror-symmetrically, and a short circuit ring 51 is arranged between the two sets, and the rotor is connected to the rotating shaft through a rotor bushing 61; the stator is formed by nesting an inner magnetic ring 41 in an outer magnetic ring 42, two sets of inner and outer magnetic rings are arranged mirror-symmetrically with respect to the radial rotor, a short circuit ring 52 is arranged on the side of the stator away from the rotor with an axial clearance.

For the magnetization directions and polarities of the bearings, the first axial maglev bearing is radially magnetized, and the second radial maglev bearing is axially magnetized. The magnetic rings 11 and 12, 21 and 22, 31 and 32, 41 and 42 are opposite in polarity, and the stators and the rotors are symmetrically attracted. In addition, shafting arrangements of the magnetic rings may be symmetrical or asymmetrical.

For the first axial maglev bearing and the second radial maglev bearing, mechanical composite bearings can be added during the actual use. On the one hand, a conical roller bearing can be provided for protection, and on the other hand, the bearing capacity can be improved by setting the number of the first axial maglev bearing or the second radial maglev bearing.

In addition, maglev state self-diagnostic detection subsystems and safety redundant bearings are standard features of modern intelligent high-reliability maglev bearings. When a maglev negative-feedback control force is greater than an external load force and an interference force, the bearing may not be protected, thereby simplifying the system structure.

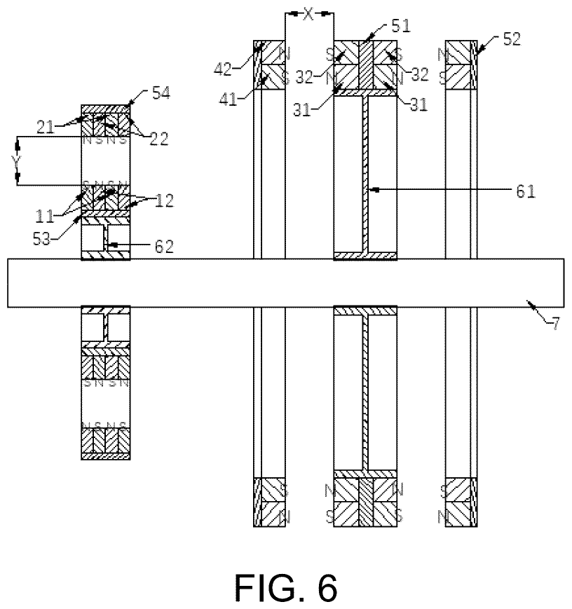

The all-permanent magnet combined self-stabilizing maglev bearing proposed in this design can be applied to green energy saving, machine manufacturing, aerospace, silent motion carrier and automobile, etc. Specifically, the design can be directly applied to a power unit of a fan device to achieve low cost and better reliability. In addition, in actual application scenarios, a basic mode is a combination form of a second radial maglev bearing and a first axial maglev bearing as shown in FIG. 6. However, the number and position of each bearing can be further selected based on the basic mode according to actual needs, and for example, two second radial maglev bearings and two first axial maglev bearings, such as second+first+second+first, or second+second+first+first in sequence, can be used.

In addition, according to different application scenarios, the first and second maglev bearings can also be used separately with mechanical bearings.

The above are only preferred embodiments of the present invention. The protection scope of the present invention is not limited to the above-mentioned embodiments. Any equivalent modifications or changes made by those of ordinary skill in the art based on the disclosure of the present invention should be included within the scope of protection stated in the claims.

1. An all-permanent magnet combined self-stabilizing maglev bearing, comprising:
first axial maglev bearing and a second radial maglev bearing arranged on a same rotating shaft, wherein the first axial maglev bearing achieves radial magnetization and axial levitation stabilization, and the second radial maglev bearing achieves axial magnetization and radial levitation stabilization; and
the first axial maglev bearing and the second radial maglev bearing each comprises a stator, a rotor and a rotor bushing, the stator and the rotor being composed of magnetic rings, the rotor is fixed on the rotating shaft by the rotor bushing, and a short circuit ring is arranged between the magnetic rings.

2. The all-permanent magnet combined self-stabilizing maglev bearing according to claim 1, wherein at least one first axial maglev bearing and one second radial maglev bearing are arranged on the rotating shaft.

3. The all-permanent magnet combined self-stabilizing maglev bearing according to claim 2, wherein numbers of the first axial maglev bearing and the second radial maglev bearing arranged on the rotating shaft are selected according to actual demands.

4. The all-permanent magnet combined self-stabilizing maglev bearing according to claim 1, wherein the first axial maglev bearing comprises a first bearing rotor and a first bearing stator; the first bearing rotor is composed of a plurality of small magnetic rings abutting to each other, a short circuit ring is arranged inside each of the small magnetic rings, and the first bearing rotor is connected to the rotating shaft through a rotor bushing; the first bearing stator is composed of a plurality of large magnetic rings abutting to each other, and a short circuit ring is arranged outside each of the large magnetic rings; and the first bearing rotor is placed in the first bearing stator with a radial clearance.

5. The all-permanent magnet combined self-stabilizing maglev bearing according to claim 4, wherein in the first bearing rotor and the first bearing stator, the small magnetic rings abutting to each other are opposite in polarity, the large magnetic rings abutting to each other are opposite in polarity, and the large and small magnetic rings that are symmetrical in position on the first bearing rotor and the first bearing stator are opposite in polarity.

6. The all-permanent magnet combined self-stabilizing maglev bearing according to claim 1, wherein the second radial maglev bearing comprises a second maglev rotor and second maglev stators; the second maglev rotor is formed by nesting inner magnetic rings in outer magnetic rings; the inner and outer magnetic rings are arranged mirror-symmetrically, and a short circuit ring is arranged between the inner and outer magnetic rings; the second maglev rotor is connected to the rotating shaft through a rotor bushing; the second maglev stator is formed by nesting inner magnetic rings in outer magnetic rings, and the inner and outer magnetic rings are respectively arranged on two sides of the second maglev rotor and arranged mirror-symmetrically; and a short circuit ring is arranged on a side of the second maglev stator away from the second maglev rotor with an axial clearance.

7. The all-permanent magnet combined self-stabilizing maglev bearing according to claim 6, wherein in the second maglev rotor and the second maglev stator, the nested inner and outer magnetic rings are opposite in polarity, and the inner and outer magnetic rings that are symmetrical in position on the second maglev rotor and the second maglev stator are opposite in polarity.

8. The all-permanent magnet combined self-stabilizing maglev bearing according to claim 1, wherein a conical roller bearing is added on the rotating shaft for protection.
